(19) United States
(12) Patent Application Publication
(10) Pub. No.: US 2005/0109710 A1
(43) Pub. Date: May 26, 2005

(54) Contamination purification system

(76) Inventors: Yukuaki Mitarai, Kamagaya-shi (JP); Yousuke Maekawa, Sapporo-shi (JP); Michiharu Tajima, Toyohashi-shi (JP)

Correspondence Address: ARMSTRONG, KRATZ, QUINTOS, HANSON & BROOKS, LLP, 1725 K STREET, NW, SUITE 1000, WASHINGTON, DC, 20006, US

(21) Appl. No.: 10/722,144

(22) Filed: Nov. 26, 2003

(51) Int. Cl. C02F 1/68

(52) U.S. Cl. 210/750

(57) ABSTRACT

A contamination purification system which can be installed in a narrow space to efficiently treat soil contaminated with a volatile organic compound, even when it is at a relatively low concentration, without needing a large-scale purification unit, and can effectively utilize the recovered volatile organic compound by its combustion/electric power generation unit. More particularly, a contamination purification system for purification of an area contaminated with a volatile organic compound, which is composed of an extraction well located in the contaminated area, gas suction/exhausting unit for extracting the volatile organic compound from the extraction well, vapor liquid separator for separating water accompanying the extracted volatile organic compound, and combustion/electric power generation unit for transforming energy produced by combusting the separated/recovered volatile organic compound into electric power, wherein the electric power produced by the combustion/electric power generation unit is used as a power for driving the contamination purification system.

### BACKGROUND OF THE INVENTION

1. Field of the Invention

The present invention relates to a contamination purification system, more particularly a contamination purification systems which can effectively treat soil contaminated with a volatile organic compound of relatively low concentration in a narrow space without needing a large-scale purification unit, and effectively utilize the recovered volatile organic compound by burning it to generate electric power

2. Description of the Prior Art

Recently, contamination of soil with a volatile organic compound has been pointed out in many areas, and procedures to purify contaminated soil need advanced technologies and experiences. The contamination of soil with a volatile organic compound has been caused by the contaminant flowing out of a storage tank or reclaimed land of wastes into soil. It could have an adverse effect on human health, when it stays in the soil, penetrates into underground water to be dissolved therein, and further stays on the water-impermeable stratum.

Some of these contaminants, e.g., benzene, have been attracting attention, and subject to the environmental standards. They may move in a liquid state through soil into underground water or may be dissolved therein, diffusing in the flow direction to expand the contaminated area, or may stay at a high concentration on the water-impermeable stratum Therefore, measures against contamination of underground water are also important.

The ground is generally composed of a stratum not saturated with water (unsaturated stratum), stratum saturated with water (saturated stratum) and water-impermeable stratum. As described above, a flowing contaminant may penetrate through the ground to stay in the unsaturated or saturated stratum, the underground, or stay on the water-impermeable stratum.

The methods generally employed for purification of underground contamination are mostly based on physical or chemical procedure. Those methods for purification of soil contaminated with a volatile organic compound at the source include sparging, water pumping-up and suction of the contaminant gas from soil, all of which fall into the physical procedure. More recently, bioremediation, which decomposes or modifies a hazardous contaminant by the actions of microorganisms, has been studied for purification treatment.

Bioremediation at the source, which treats soil at the contaminant source, is advantageous in that it decomposes and removes a contaminant or makes it harmless on a perpetual basis at the source without taking up the contaminant to the earth's surface. Moreover, it is accepted that this method is effective against a phenomenon observed in the physical or chemical procedure, in which restoration is greatly decelerated when concentration of the hazardous component in question decreases to a certain low level.

However, it is necessary for bioremediation at the source to grow microorganisms capable of decomposing or modifying a contaminant in the contaminated underground area from which it is to be removed, and hence to supply nutrients or the like to the microorganisms from the earth's surface to the underground. Moreover, the microorganisms are active only in the water-saturated stratum (aquifer), and are ineffective against a contaminant distributed in the water-unsaturated stratum on underground water. It is pointed out that rapid activation of microorganisms in the water-unsaturated stratum cannot be expected by merely injecting nutrients or the like to them, because the nutrient solution mostly penetrates downwards from the injection point and penetrates horizontally to a much lesser extent.

By contrast, the soil gas suction method has been applied to purification at the contamination source in the soil 4 in the water-unsaturated stratum 1, shown in FIG. 8(a). As shown, a vaporized volatile organic compound is extracted by a suction pump 20 through the extraction well 6 into the vapor-liquid separator 30 in the contamination purification system 15, from which it is sent by a blower 21 to the gas treating unit 35, where it is treated to be harmless. In other words, a volatile organic compound deposited on soil particles or present between the particles as a gaseous contaminant is extracted by a suction pump 20 through the extraction well 6, and eventually treated to be harmless by the gas treating unit (incinerator) 35. As such, this method is considered to be a central procedure among contamination purification systems.

The sparging method is generally used as a purification method at a source for underground water 5 in the water-saturated stratum 2. Referring to FIG. 8(b), the air-injection unit 23 in the contamination purification system 15 injects air into underground water via the sparging well 7 to vaporize a volatile organic compound by the air. In general, the gas extracted via the extraction well 6 is eventually treated to be harmless by the gas treating unit 35 in the contamination purification system 15, as is the case with the soil gas suction method The sparging method, therefore, is considered to be useful.

The water pumping-up method is also used as a purification method at a source for underground water 5 in the water-saturated stratum 2 Referring to FIG. 8(c), underground water contaminated with a volatile organic compound is pumped up through the water pumping-up well 8, located in the water-saturated stratum 2, by the water discharge pump 24 in the contamination purification system 15, passed to the aeration tank 34 in the contamination purification system 15, and discharged after being purified. The gas separated in the aeration tank 34 from the contaminated underground water is sent to the gas treating unit 36 by the blower 21, where it is treated to be harmless. As such, the water pumping-up method is also considered to be useful.

Another method proposed to use a suction pump for lifting underground water is the one for recovering oil of high viscosity coefficient, disclosed by Japanese Patent Publication No. 10-258266. It forms a water-impermeable stratum on the ground of water-saturated stratum below the contaminated area, separates the formed stratum from the peripheries by sheet piles, and supplies wash water under pressure to the water-impermeable stratum via a well to cause a flow of the wash water towards the earth's surface, where oil included in the returned wash water is recovered and treated. However, this method is for recovering oil of high viscosity coefficient, and the publication is silent on purification by removing a volatile organic compound.

The gas treating unit 35 or 36 for each of the methods described above can treat a volatile organic compound by various methods, e.g., active carbon method, catalytic method which decomposes the contaminant in the presence of catalyst, and incineration, e.g., thermal storage type combustion method in which a burner-equipped combustion chamber is combined with a thermal storage chamber. Moreover, one of the methods to decompose a volatile organic compound present in water uses a bioreactor.

Of these methods, the active carbon method adsorbs a volatile organic compound in a gas stream on the active carbon, where the spent active carbon is disposed of in a final disposal site or incinerated together with the contaminant. This method invariably needs a large-scale system, which includes an adsorption tower for the active carbon. It is therefore unsuitable to locate in a narrow space, e.g., site left by a gasoline station.

The catalytic method decomposes a volatile organic compound by oxidation in the presence of a precious metal catalyst. This method tends to suffer unstable reactions when concentration of the volatile organic compound (to be treated by this method) fluctuates, and excessively increased reaction temperature when its concentration exceeds 1,000 ppm, which may damage the catalyst. Therefore, the system generally needs an excessive amount of catalyst, an auxiliary unit for diluting the volatile organic compound with air, or a downstream adsorption tower packed with active carbon. As a result, the catalytic method is also unsuitable to locate in a narrow space for treating contaminated soil, because it needs a relatively large-scale reaction tower packed with a catalyst and, in some cases, an adsorption tower packed with active carbon.

The thermal storage type combustion method in which a burner-equipped combustion chamber is combined with a thermal storage chamber is originally developed to treat a volatile organic compound in an off-gas stream discharged from a chemical plant. The system comprises a burner-equipped combustion chamber and thermal storage chamber as the major units. This method burns the off-gas in the combustion chamber with the aid of a fuel, e.g., propane, to decompose the volatile organic compound by oxidation, and passes the resulting combustion gas through the thermal storage layer in the heat-accumulative chamber to heat the layer, where the off-gas discharged from a plant flows into the layer to be pre-heated and then passed to the combustion chamber to be burnt therein, as described above This design prevents condensation and deposition of the volatile organic compound in the system. This method is advantageous in that it can enhance thermal efficiency to 95% or more in the treatment unit by a combination of preheating and combustion of an off-gas as the feed stream. Nevertheless, however, it is also unsuitable to locate in a narrow space for treating contaminated soil, because it needs a large-scale unit of thermal storage chamber.

A method involving a bio-reactor needs microorganisms to decompose a contaminant, and environmental management for nutrients, temperature or the like to keep the microorganisms activated. Therefore, it is not an easily applicable treatment method.

In each of the methods described above, the recovered volatile organic compound is decomposed or disposed of in a gas treating unit, and is not effectively utilized as an energy source, e.g., that for electric power generation.

Under these situations, there are keen demands for contamination purification systems which can effectively treat soil contaminated with a volatile organic compound of relatively low concentration in a narrow space without needing a large-scale purification unit, and effectively utilize the recovered volatile organic compound by burning it to generate electric power.

### SUMMARY OF THE INVENTION

It is an object of the present invention to provide a contamination purification system which can effectively treat soil contaminated with a volatile organic compound of relatively low concentration in a narrow space without needing a large-scale purification unit, in consideration of the problems involved in the conventional techniques.

The inventors of the present invention have found, after having extensively studied to attain the above object, that a volatile organic compound treated by vapor-liquid separation or deaeration can be effectively utilized as a fuel for a system involving combustion and electric power generation, because it contains air and shows good combustibility, where the volatile organic compound is collected by suction and extraction using at least one of soil gas suction, sparging and water pumping-up applied to the contaminated soil, and then treated by vapor-liquid separation or deaeration, achieving the present invention.

The first aspect of the present invention is a contamination purification system for purification of an area contaminated with a volatile organic compound, which is composed of an extraction well located in the contaminated area, gas suction/exhausting unit for extracting the volatile organic compound from the extraction well, vapor-liquid separator for separating water accompanying the extracted volatile organic compound, and combustion/electric power generation unit for transforming energy produced by combusting the separated/recovered volatile organic compound into electric power, wherein the electric power produced by the combustion/electric power generation unit is used as a power for driving the contamination purification system.

The second aspect of the present invention is a contamination purification system for purification of an area contaminated with a volatile organic compound, which is composed of an air-injection well and extraction well located in at least one of the water-impermeable, water-saturated and water-unsaturated stratum all located in the contaminated area, (at the upper end when located in the water-impermeable stratum), an air injection and gas suction/exhausting unit for extracting the volatile organic compound from the extraction well, vapor-liquid separator for separating water accompanying the extracted volatile organic compound, and combustion/electric power generation unit for transforming energy produced by combusting the separated/recovered volatile organic compound into electric power, wherein the electric power produced by the combustion/electric power generation unit is used as a power for driving the contamination purification system.

The third aspect of the present invention is a contamination purification system for purification of an area contaminated with a volatile organic compound, which is composed of a water pumping-up well, located in the contaminated area, suction pump for lifting water containing a volatile organic compound through the pumping-up well, decomposing unit for purifying the lifted water, deaeration unit for aerating the water purified by the decomposing unit to recover the volatile organic compound, and combustion/electric power generation unit for transforming energy produced by combusting the separated/recovered volatile organic compound into electric power, wherein the electric power produced by the combustion/electric power generation unit is used as a power for driving the contamination purification system.

The fourth aspect of the present invention is a contamination purification system for purification of an area contaminated with a volatile organic compound, which is composed of an extraction well and water pumping-up well all located in the contaminated area, gas suction/exhausting unit for extracting the volatile organic compound from the extraction well, vapor-liquid separator for separating water accompanying the extracted volatile organic compound, suction pump for lifting water containing a volatile organic compound through the pumping-up well, decomposing unit for purifying the lifted water, deaeration unit for aerating the water purified by the decomposing unit to recover the volatile organic compound, and combustion/electric power generation unit for transforming energy produced by combusting the separated/recovered volatile organic compound into electric power, wherein the electric power produced by the combustion/electric power generation unit is used as a power for driving the contamination purification system.

The fifth aspect of the present invention is a contamination purification system for purification of an area contaminated with a volatile organic compound, which is composed of an air injection well, extraction well and water pumping-up well, all located in at least one of the water-impermeable, water saturated and water-unsaturated stratum (at the upper end when located in the water-impermeable stratum), an air injection and gas suction/exhausting unit for extracting the volatile organic compound from the extraction well, vapor-liquid separator for separating water accompanying the extracted volatile organic compound, suction pump for lifting water containing a volatile organic compound through the pumping up well, decomposing unit for purifying the lifted water, deaeration unit for aerating the water purified by the decomposing unit to recover the volatile organic compound, and combustion/electric power generation unit for transforming energy produced by combusting the volatile organic compound, recovered by the vapor-liquid separator and deaeration unit, into electric power, wherein the electric power produced by the combustion/electric power generation unit is used as a power for driving the contamination purification system.

The sixth aspect of the present invention is the contamination purification system of one of the first to fifth aspects, wherein the combustion/electric power generation unit uses a gas turbine.

The seventh aspect of the present invention is the contamination purification system of one of the third to fifth aspects, wherein the decomposing unit decomposes the lifted water in the presence of ultraviolet ray or photocatalyst.

### BRIEF DESCRIPTION OF THE DRAWINGS

FIG. 1 outlines the contamination purification system of the present invention involving the soil gas suction method.

FIG. 2 outlines the contamination purification system of the present invention involving the sparging method.

FIG. 3 outlines the contamination purification system of the present invention involving the water pumping-up method.

FIG. 4 outlines the contamination purification system of the present invention involving a combination of the soil gas suction method and water pumping-up method.

FIG. 5 outlines the contamination purification system of the present invention involving a combination of the sparging method and water pumping-up method.

FIG. 6 illustrates details of the combustion/electric power generation unit for the contamination purification system of the present invention

FIG. 7 presents a graph showing a situation of recovering gasoline from soil in EXAMPLE in which the present invention was applied.

FIG. 8 outlines the conventional contamination purification system, involving the (a) soil gas suction method, (b) sparging method, and (c) water pumping-up method.

### NOTATION

1, 4 Water-unsaturated stratum, Soil
2 Water-saturated stratum
3 Water-impermeable stratum
6, 7, 8 Well (Extraction, sparging and water pumping-up well)
5, 9 Underground water, lifted water
10, 11 Air containing a volatile organic compound
12, 15 Contamination purification section
20, 21, 25 Fan
23, 24 Pump
30, 34 Vapor-liquid separator, deaeration unit
32 Decomposing unit
40 Combustion/electric power generation unit

### DETAILED DESCRIPTION OF THE INVENTION

The contamination purification system of the present invention collects a volatile organic compound from soil contaminated therewith by suction (extraction) together with air or water which carries the compound, recovers the compound by vapor-liquid separation (deaeration), and supplies the recovered compound to a combustion/electric power generation unit, where it is, effectively utilized as a fuel It adopts at least one of soil gas suction, sparging and water pumping-up as the procedure for collecting the volatile organic compound by suction (extraction).

The volatile organic compounds which can be treated by the present invention include various hydrocarbons and mixtures thereof. Some of more typical hydrocarbons are straight-chain or branched aliphatic compounds, e.g., hexane, heptane and octane; unsaturated compounds, e.g., olefins; and aromatic compounds, e.g., benzene, toluene, ethylbenzene and xylene. They are components for fuels, e.g., gasoline and solvents, among others. The other organic compounds which can be treated by the present invention include oxygen-containing hydrocarbons, e.g., ketones, ethers, alcohols, organic acids and phenols; and petrochemical products which incorporate these compounds as solvent components or which are produced from these compounds as the starting materials.

The petroleum products, e.g., kerosene, gas oil, lubricants, machine oils, metal machining oils, paraffins and waxes which are produced by distillation and refining of crude oils and may be incorporated with a varying additive, as required, fall into the volatile organic compounds of broad sense in the present invention. Heavy fuels and asphalt, which in themselves are not volatile organic compounds but can be decomposed to lighter hydrocarbons, are subjects for treatment so long as they are carried by air or water.

Organic chlorine compounds, organic cyan compounds or dioxins can be treated by the decomposing or combustion/electric power generation unit of the present invention, when carried by the volatile organic compound.

The following contamination purification systems fall into the scope of the present invention.

(1) The Contamination Purification System which Adopts a Soil Gas Suction Method

This system is suitable for treating a volatile organic compound which contaminates soil mainly in the water-unsaturated stratum in the contaminated area It is regarded as a particularly effective system among those falling into the scope of the present invention, because it can efficiently recover and utilize a volatile organic compound.

This confamination purification system is composed of an extraction well located in the water-unsaturated stratum, gas suction/exhausting unit for extracting the volatile organic compound from the extraction well, vapor-liquid separator and combustion/electric power generation unit, wherein the combustion/electric power generation unit uses a gas turbine, and the electric power produced by this unit is used as a power for driving the contamination purification system.

The extraction well is provided to collect a volatile organic compound from the water-unsaturated stratum, and is linked to a unit including a suction fan or the like, provided on the earth's surface A volatile organic compound or the like can be rapidly extracted from an adequate point in the underground area where the volatile organic compound is present at a high density by optimizing number/disposition of the wells and the operating procedure.

This system collects a volatile organic compound together with air carrying the compound by a suction unit from the extraction well, and uses the mixture as a combustion air for the combustion/electric power generation unit, after mist is removed by the vapor-liquid separator. The volatile organic compound is efficiently burnt in the combustion/electric power generation unit, and the resulting combustion gas drives the turbine in the unit to produce electric power, which can be used as a power for driving the contamination purification system. It can be said that this system is particularly suitable for purifying contamination with a highly volatile organic compound.

(2) The Contamination Purification System which Adopts a Sparging Method

This system is suitable for treating a volatile organic compound which contaminates soil not only in the water-unsaturated stratum but also in the water-unsaturated and water-saturated stratum.

This contamination purification system is composed of a sparging well and extraction well, air injection unit and gas suction/exhausting unit for extracting the volatile organic compound, vapor-liquid separator, and combustion/electric power generation unit, wherein the combustion/electric power generation unit uses a gas turbine, and the electric power produced by this unit used as a power for driving the contamination purification system.

The sparging well is provided to blow air into the underground water dissolving a volatile organic compound and thereby to drive off the compound from the underground water.

This contamination purification system injects air into underground water through the sparging well from the air injection unit in the same system, and thereby can vaporize the volatile organic compound dissolved in the underground water. The volatile organic compound vapor is extracted together with a volatile organic compound present in the water-unsaturated stratum by a suction pump from the extraction well in the gaseous state for treatment.

This system injects air into soil containing underground water to vaporize a volatile organic compound present therein, extracts the compound together with air, and uses the mixture as a combustion air for the combustion/electric power generation unit, after mist is removed by the vapor-liquid separator. The volatile organic compound is efficiently burnt in the combustion/electric power generation unit, and the resulting combustion gas drives the turbine in the unit to produce electric power, which is used as a power for driving the contamination purification system.

At least one sparging well is installed in such a way to locate the strainer provided at the end of the well in the water-unsaturated stratum in the contaminated area, to blow air into the underground area. When the extraction wells are operated at least at two points in the contaminated area around the air-injection point within the range in which the vacuum effect is exerted, the capillary phenomenon is amplified to diffuse air over a wider area in the contaminated, water-unsaturated stratum. Air can be diffused over a still wider area, when the strainers for the sparging well are located at two or more depths and, at the same time, the suction by the extraction wells is carried out intermittently in response to rate of air injected from the sparging well and water penetration rate in the water-unsaturated stratum to which it is applied.

This system can puri the contaminated area more rapidly while limiting the effect on the ambient environment, when combined in a contamination purification system for the water-saturated stratum below the underground water level.

(3) The Contamination Purification System which Adopts a Water Pumping-Up Method

This system is effective when a volatile organic compound to be removed is present mainly in underground water. It is also applicable when a volatile organic compound to be removed has a higher boiling point or more difficult to decompose.

This contamination purification system is composed of a water pumping-up well, suction pump for lifting underground water, decomposing unit for treating the volatile organic compound contained in the lifted water, deaeration unit and combustion/electric power generation unit.

The decomposing unit decomposes the volatile organic compound in the presence of ultraviolet ray or photocatalyst. It can decompose a volatile organic compound of relatively high boiling point dissolved in the lifted water into the lighter volatile organic compound, which can be sent together with the volatile organic compound, which has been already separated, to the combustion/electric power generation unit The electric power produced by the combustion/electric power generation unit is used as a power for driving the contamination purification system.

When ultraviolet ray is used, the contamination purification system may be irradiated with ultraviolet ray alone or ultraviolet ray and ozone simultaneously. It is accepted that ultraviolet ray having a wavelength of 180 to 260 nm works to decompose a volatile organic compound Use of ozone in combination with ultraviolet ray is expected to further accelerate decomposition of a volatile organic compound by its oxidation effect.

The photocatalyst, when used, is generally of titania (TiO₂). The photocatalysts useful for the present invention include a titanium-based active metal supported on alumina, silica, silica-alumina or glass The photocatalyst may be dispersed in the form of fine particles, or place in water in the form of pellets or thin plates or the like. The photocatalyst, when irradiated with solar energy containing the ultraviolet ray region, comes to show a capacity of decomposing a volatile organic compound even at room temperature, because of the hydroxyl radical it produces from water. Use of ozone or ultraviolet ray is expected to further accelerate decomposition of a volatile organic compound also in this case.

The deaeration unit is normally equipped with a vapor-liquid separator, e.g., mist separator. If not, the deaeration unit is followed by a vapor-liquid separator. In the decomposing unit working in the presence of ozone or photocatalyst, the hydrocarbyl radicals produced may be recombined with each other to have a higher molecular weight. However, the organic compound of higher molecular weight floats on the water surface and can be easily separated by a filter.

(4) The Contamination Purification System which Adopts a Water Pumping-Up Method Combined with a Soil Gas Suction or Sparging Method

First, the system in which the soil gas suction method is combined with the water pumping-up method is described. This system produces a synergistic effect of the systems (1) of the first aspect of the present invention and (3) of the third aspect of the present invention described above over the combination of the effect which each system brings.

This contamination purfication system is composed of an extraction well and water pumping-up well located in the contamination area, gas suction/exhausting unit for extracting the volatile organic compound from the extraction well, vapor-liquid separator, suction pump for lifting underground water through the pumping-up well, decomposing unit for treating the volatile organic compound contained in the lifted water, deaeration unit and combustion/electric power generation unit, wherein the combustion/electric power generation unit uses a gas turbine, and the electric power produced by this unit is used as a power for driving the contamination purification system.

This system collects a volatile organic compound vapor from soil via the extraction well together with air, and removes concomitant mist by the vapor-liquid separator to obtain air “a.” It also pumps up a volatile organic compound present in soil together with underground water The contaminated lifted water is irradiated with ultraviolet ray, preferably in the presence of ozone, in the decomposing unit to decompose the volatile organic compound, and then treated by the deaeration unit, e.g., aeration tank, to extract the volatile organic compound. The air contaminated with the compound is referred to air “b.” The air “a” is combined with the air “b” to be used as combustion air for the combustion/electric power generation unit to efficiently combust the volatile organic compound. The turbine in this unit is driven by the resulting combustion gas to produce electric power, which is used as a power for driving the contamination purification system.

The decomposing unit decomposes the volatile organic compound by the aid of a photocatalyst, or ultraviolet ray preferably in the presence of ozone.

Next, the system in which the sparging method is combined with the water pumping-up method is described This system produces a synergistic effect of the systems (2) of the second aspect of the present invention and (3) of the third aspect of the present invention described above over the combination of the effect which each system brings.

This contamination purification system is composed of wells located at least in the water-impermeable stratum on the upper end, water-saturated or water-unsaturated stratum in the contaminated area, air-injection unit for extracting the volatile organic compound, and gas suction/exhausting unit, suction pump for lifting water, decomposing unit for treating the volatile organic compound in the lifted water, deaeration unit, vapor-liquid separator and combustion/electric power generation unit, wherein the wells are composed of the sparging well for air injection, extraction well and pumping-up well for lifting water, and the combustion/electric power generation unit includes a gas turbine to produce electric power, which is used as a power for driving the contamination purification system.

This system injects air into soil to vaporize a volatile organic compound present therein; extracts the compound together with air; irradiates air containing the volatile organic compound, treated by a vapor-liquid separator to remove mist, and lifted underground water containing the volatile organic compound with ultraviolet ray, preferably in the presence of ozone, to decompose the volatile organic compound in the lifted water; extracts the volatile organic compound from the lifted water into air by a deaeration unit, e.g. aeration tank; and combines air with the air containing the volatile organic compound to use the mixture as a combustion air for the combustion unit The volatile organic compound is efficiently burnt in the combustion unit, and the resulting combustion gas drives the turbine in electronic power generation unit to produce electric power, which is used as a power for driving the contamination purification system. This system is effective to treat various organic compounds of different volatility.

The column test and investigations of geological features and conditions of the contaminated area are needed before an adequate contamination purification system is selected. The column test is carried out while taking into consideration the site characterization for grasping underground conditions of the contaminated area and information obtained by the flask test results, to obtain the data (e.g., construction techniques, cost and time, among others) necessary for designing and construction of the system on the site.

These efforts are expected to produce more reliable data for the volatile organic compound distribution in the contaminated area, construction of the system, and cost and time needed for the purification.

The preferred embodiments of the present invention are described by referring to the drawings, to clarify each embodiment which can be composed of various purification methods.

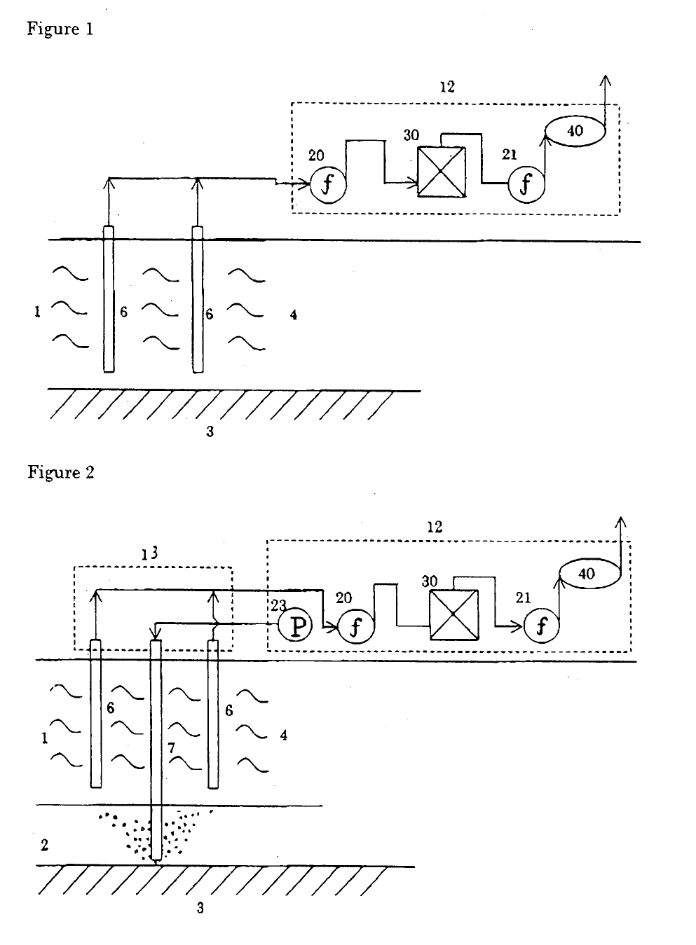

FIG. 1 outlines the contamination purification system of the first aspect of the present invention A contaminant flowing out of wastes discarded in the ground composed of the water-unsaturated stratum 1, water-saturated stratum 2 and water-impermeable stratum 3 or from liquid or the like stored in a tank in the ground penetrates from the original site through the soil and stays in the soil 4 in the water-unsaturated stratum 1.

Two or more wells for the system of the present invention are the extraction wells 6 located in the water-unsaturated stratum 1. These wells themselves are disposed in each of the above strata in response to conditions of the contamination purification range, among others.

Referring to FIG. 1, the extraction well 6 is for extracting a volatile organic compound vaporizing from the soil, and the extracted compound is passed to the contamination purification section 12 together with air by a suction fan 20.

In this embodiment, the contamination purification section 12 constitutes the contamination purification system in such a way that the fan 21 and treatment unit 40 as its components are linked in a given manner to treat the volatile organic compound extracted from the soil.

The treatment mechanisms of this contamination purification system are described. First, the volatile organic compound rising through the extraction well 6 is collected together with air by a suction fan 20, and passed to the vapor-liquid separator 30, where the concomitant mist is removed from the air stream. The air is passed to the combustion/electric power generation unit 40 by an exhausting fan 21, where it is used as combustion air to burn kerosene, gas oil or the like as the fuel for the unit. The recovered volatile organic compound is burnt to be harmless.

The contamination purification system may be operated without the suction fan 20 depending on quantity of air to be collected by suction. This system, collecting contaminated air only by the exhausting fan 21, is within the scope of the present invention.

In this system, the upper limit of air quantity collectable from the extraction well 6 is determined only by quantity of the combustion air required by the combustion/electric power generation unit 40. It is therefore preferable to determine capacity of the unit 40 in response to quantity of the gas to be collected from the extraction well 6. Viewed from this point, the combustion/electric power generation unit 40 can sufficiently exhibit the required function by a small-size unit, e.g., brand name, Capstone's Capstone, Turbine Generator Model 330. The electric power produced by this unit is used as a power for driving each unit in the contamination purification system⁻¹ The electric power, when produced in excess of the requirement of the system, may be sold.

This system may be operated by an air compressor in place of the exhausting fan 21. In such a system, it is preferable to prevent formation of an explosive mixture for safety reason by limiting a volatile organic compound content in the air to 2% or less.

This system is preferably equipped with one or more pressure sensors, temperature sensors and analyzers each at a given position in the gas or liquid transfer line. Sufficient air-tightness shall be secured at the connection between each unit and piping system to prevent a fire or explosion caused by the leaked volatile organic compound in the combustion/electric power generation unit or the like.

FIG. 2 outlines the contamination purification system of the second aspect of the present invention. A contaminant flowing out of wastes discarded in the ground or from liquid or the like stored in a tank in the ground penetrates from the original site through the soil and stays in the soil 4 in the water-unsaturated stratum 1 or water-saturated stratum 2. It may also penetrate into underground water 5 to be dissolved therein, or may stay on the upper end of the water-impermeable stratum 3 in some cases.

Two or more wells for this system are the extraction wells 6 disposed in the water-unsaturated stratum 1, and the spaiging well 7 disposed in the water-saturated stratum 2. These wells are disposed in each of the above strata or on the upper end of the water-impermeable stratum 3 in response to conditions of the contamination purification range, among others.

The extraction section 13 is composed of the extraction wells 6 for extracting gas from soil, and the well working as the sparging well 7 for injecting air into underground water.

The contamination purification section 12 constitutes the contamination purification system in such a way that the pump 23, fans 20 and 21, and treatment unit 40 as its components are linked in a given manner to treat the volatile organic compound extracted from the soil.

The treatment mechanisms of this contamination purification system are described First, air is blown into soil through the sparging well 7 by the air-injection pump 23 as the air-injection unit, to vaporize a volatile organic compound present in the soil, which is collected together with air from the extraction well 6 by a suction fan 20 and passed to the vapor-liquid separator 30, where the concomitant mist is removed from the air stream. The air is passed to the combustion/electric power generation unit 40 by an exhausting fan 21, where it is used as combustion air to burn kerosene, gas oil or the like as the fuel for the unit. The recovered volatile organic compound is burnt to be harmless.

The contamination purification system may be operated without the suction fan 20 depending on quantity of air to be collected by suction. This system, collecting contaminated air only by the exhausting fan 21, is within the scope of the present invention. In this system, the upper limit of air quantity collectable from the extraction well 6 is determined only by quantity of the combustion air required by the combustion/electric power generation unit. It is therefore preferable to determine capacity of the unit 40 in response to quantity of the gas to be collected from the extraction well 6.

The combustion/electric power generation unit 40 can sufficiently exhibit the required function by a small-size unit, e.g., brand name, Capstone's Capstone Turbine Generator Model 330. The electric power produced by this unit is used as a power for driving each unit in the contamination purification system. The electric power, when produced in excess of the requirement of the system, may be sold.

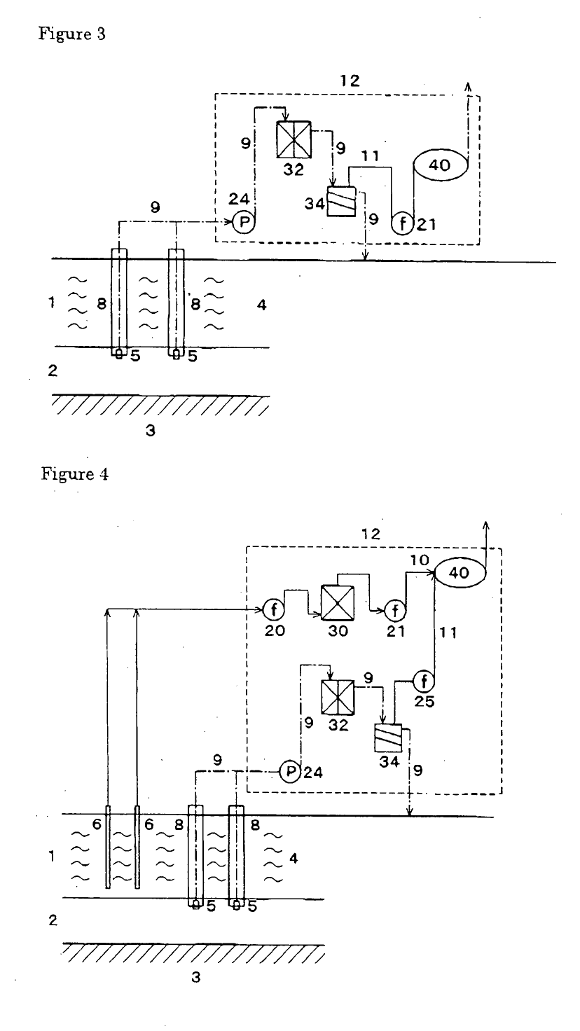

As illustrated in FIG. 2, this system amplifies the capillary phenomenon towards the extraction well 6 point from the sparging well 7 point, to diffuse air over a wider area in the contaminated, water-unsaturated stratum 1. Air can be diffused over a still wider area, when a plurality of the extraction wells 6 are operated simultaneously or alternately for intermittent operation. Operation of the extraction well 6 is expected to bring the auxiliary effect of blowing air from the earth's surface into underground FIG. 3 outlines the contamination purification system of the third aspect of the present invention. A contaminant stays in the soil 4 in the water-unsaturated stratum 1 or water-saturated stratum 2, or penetrates into underground water 5 to be dissolved therein. It may also stay on the upper end of the water-impermeable stratum 3 in some cases.

Two or more wells for this system are the water pumping-up wells 8 disposed in the water-saturated stratum 2. These wells are disposed in each of the above strata or on the upper end of the water-impermeable stratum 3 in response to conditions of the contamination purification range, among others.

The contamination purification section 12 constitutes the contamination purification system in such a way that the pump 24, fan 21, and treatment unit 40 as its components are linked in a given manner to treat the volatile organic compound in the underground water.

The treatment mechanisms of this contamination purification system are described. First, underground water 9 containing a volatile organic compound is lifted by the suction pump 24 through the water pumping-up well 8, and passed to the decomposing unit 32. Any type of decomposing unit may be used so long as it can decompose the volatile organic compound present in water. At present, the preferable type is the one decomposing the compound by the aid of ultraviolet ray in the presence or absence of ozone or photocatalyst. Use of ultraviolet ray in the presence of ozone is particularly preferable, viewed from decreasing size of the unit.

The volatile organic compound in air should be irradiated with ultraviolet ray in 2 or more stages to be completely decomposed by the decomposing unit 32 alone, which invariably increases its size. Therefore, the decomposing unit of this type is normally combined with a downstream unit of active carbon adsorption tower. This configuration invariably increases size of the whole unit, and pushes up the running cost resulting from treatment of the active carbon.

In this system, the volatile organic compound is treated to be harmless by the combustion/electric power generation unit 40. For this purpose, the underground water 9 flowing out of the decomposing unit 32 is passed to the deaeration unit 34. In this system, the deaeration unit 34 treats the underground water 9 by aeration, where the volatile organic compound is extracted in the aeration tank into the aeration air 11, which is passed to the combustion/electric power generation unit 40 by the fan 21 to be used as the combustion air. The volatile organic compound is burnt in this unit and made harmless. The underground water 9 treated to remove the volatile organic compound is discharged.

In this system, the upper limit of air quantity for the deaeration unit 34 is determined only by quantity of the combustion air required by the combustion/electric power generation unit 40. It is therefore preferable to determine capacity of the unit 40 in response to quantity of the air to be used for the deaeration unit.

The combustion/electric power generation unit 40 can sufficiently exhibit the required function by a small-size unit, e.g., brand name, Capstone's Capstone Turbine Generator Model 330. The electric power produced by this unit is used as a power for driving each unit in the contamination purification system. The electric power, when produced in excess of the requirement of the system, may be sold.

The deaeration unit is normally equipped with a vapor-liquid separator, e.g., mist separator. If not, the deaeration unit is followed by a vapor-liquid separator.

FIG. 4 outlines the contamination purification system of the fourth aspect of the present invention. A contnminant stays in the soil 4 in the water-unsaturated stratum 1 or water-saturated stratum 2, or penetrates into underground water 5 to be dissolved therein. It may also stay on the upper end of the water-impermeable stratum 3 in some cases.

Two or more wells for this system are the extraction wells 6 and water pumping-up wells 8 disposed in the water-unsaturated stratum 1 and water-saturated stratum 2, respectively. These wells themselves are disposed in each of the above strata or on the upper end of the water-impermeable stratum 3 in response to the range and conditions of the contamination purification section, among others.

The extraction well 6 is for extracting a volatile organic compound vaporizing from the soil, and the extracted compound is passed to the contamination purification section 12 together with air by a suction fan 20. The water pumping-up well 8 is for lifting underground water containing a volatile organic compound, and passing it to the contamination purification section 12.

In this embodiment, the contamination purification section 12 constitutes the contamination purification system in such a way that the pump 24, fans 21 and 25, and treatment unit 40 as its components are linked in a given manner to treat the volatile organic compound extracted from the underground soil or contained in underground water.

The treatment mechanisms of this contamination purification system are described. First, the volatile organic compound rising through the extraction well 6 is collected together with air by a suction fan 20, and passed to the vapor-liquid separator 30, where the concomitant mist is removed from the air stream. The air is passed to the combustion/electric power generation unit 40 by an exhausting fan 21.

At the same time, underground water 9 containing a volatile organic compound is lifted by the suction pump 24 through the water pumping-up well 8, and passed to the decomposing unit 32. Any type of decomposing unit may be used so long as it can decompose the volatile organic compound present in water, as discussed above.

The volatile organic compound in air should be irradiated with ultraviolet ray in 2 or more stages to be completely decomposed by the decomposing unit 32 alone, which invariably increases its size. Therefore, the decomposing unit of this type is normally combined with a downstream unit of active carbon adsorption tower. This configuration invariably increases size of the whole unit, and pushes up the running cost resulting from treatment of the active carbon.

In this system, the volatile organic compound is treated to be harmless by the combustion/electric power generation unit. For this purpose, the underground water 9 flowing out of the decomposing unit 32 is passed to the deaeration unit 34. In this system, the deaeration unit 34 treats the underground water by aeration, where the volatile organic compound is extracted in the aeration tank into the aeration air 11, which is passed to the combustion/electric power generation unit 40 by the fan 25 to be used as the combustion air. The volatile organic compound is burnt in this unit and made harmless. The underground water 9 treated to remove the volatile organic compound is discharged.

For example, air discharged from the vapor-liquid separator 30 may be used as the deaeration air for the deaeration unit 34. In this case, the system may be operated by the exhausting fan 25 without needing the fan 21. Moreover, when the deaeration unit 34 is not equipped with a mist-removing unit, e.g., mist separator, mist in the combustion air may be removed by use of the deaeration piping system for the deaeration unit 34 also as the inlet piping system for the vapor-liquid separator 30. In this case, the fan 25 may be removed. These variations are also within the scope of the present invention.

In this system, the upper limit of total quantity of air collected from the extraction well 6 and air which can be used as the deaeration air for the deaeration unit 34 is determined only by quantity of the combustion air required by the combustion/electric power generation unit 40. It is therefore preferable to determine capacity of the unit 40 in response to quantity of the air to be used.

The combustion/electric power generation unit 40 can sufficiently exhibit the required function by a small-size unit. The electric power produced by this unit is used as a power for driving each unit in the contamination purification system. The electric power, when produced in excess of the requirement of the system, may be sold.

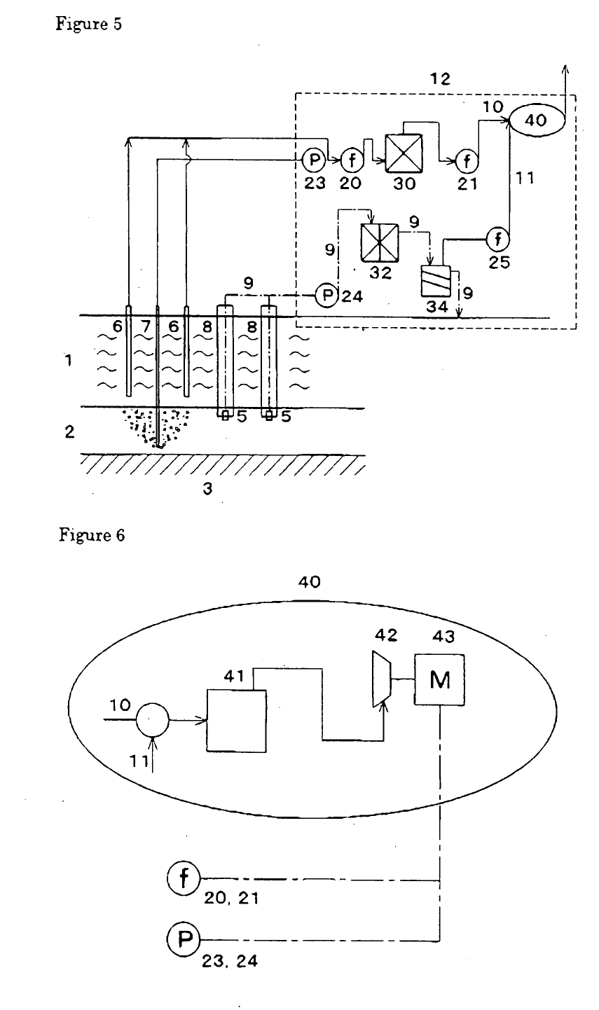

FIG. 5 outlines the contamination purification system of the fifth aspect of the present invention. A contaminant stays in the soil 4 in the water-unsaturated stratum 1 or water-saturated stratum 2, or penetrates into underground water 5 to be dissolved therein. It may also stay on the upper end of the water-impermeable stratum 3 in some cases.

Two or more wells for this system are the extraction wells 6, a sparging well 7 and water pumping-up wells 8 disposed in the water-unsaturated stratum 1, water-saturated stratum 2 and water-saturated stratum 2, respectively. These wells themselves are disposed in each of the above strata or on the upper end of the water-impermeable stratum 3 in response to the range and conditions of the contamination purification section, among others.

The extraction well 6, sparging well 7 and water pumping-up well 8 work to extract a volatile organic compound from the soil, to inject air into underground water, and to lift underground water containing a volatile organic compound, respectively.

In this embodiment, the contamination purification section 12 constitutes the contamination purification system in such a way that the pump 24, fans 21 and 25, and treatment unit 40 as its components are linked in a given manner to treat the volatile organic compound extracted from the underground water and soil.

The treatment mechanisms of this contamination purification system are described. First, air is blown into soil through the sparging well 7 by the air-injection pump 23 as the air-injection unit, to vaporize a volatile organic compound present in the soil, which is collected together with air from the extraction well 6 by a suction fan 20 and passed to the vapor-liquid separator 30, where the concomitant mist is removed from the air stream. The air is passed to the combustion/electric power generation unit 40 by an exhausting fan 21.

At the same time, underground water 9 containing a volatile organic compound is lifted by the suction pump 24 through the water pumping-up well 8, and passed to the decomposing unit 32. Any type of decomposing unit may be used so long as it can decompose the volatile organic compound present in water, as discussed above.

The volatile organic compound in air should be irradiated with ultraviolet ray in 2 or more stages to be completely decomposed by the decomposing unit 32 alone, which invariably increases its size. Therefore, the decomposing unit of this type is normally combined with a downstream unit of active carbon adsorption tower This configuration invariably increases size of the whole unit, and pushes up the running cost resulting from treatment of the active carbon.

In this system, the volatile organic compound is treated to be harmless by the combustion/electric power generation unit 40. For this purpose, the underground water 9 flowing out of the decomposing unit 32 is passed to the deaeration unit 34. In this system, the deaeration unit 34 treats the underground water by aeration, where the volatile organic compound is extracted in the aeration tank into the aeration air 11, which is passed to the combustion/electric power generation unit 40 by the fan 25 to be used as the combustion air. The volatile organic compound is burnt in this unit and made harmless. The underground water 9 treated to remove the volatile organic compound is discharged.

Air discharged from the vapor-liquid separator 30 may be used as the deaeration air for the deaeration unit 34. In this case, the system may be operated by the exhausting fan 25 without needing the fan 21. Moreover, when the deaeration unit 34 is not equipped with a mist-removing unit, e.g., mist separator, mist in the combustion air may be removed by use of the deaeration piping system for the deaeration unit 34 also as the inlet piping system for the vapor-liquid separator 30. In this case, the fan 25 may be removed. These variations are also within the scope of the present invention.

In this system, the upper limit of total quantity of air collected from the extraction well 6 and air which can be used as the deaeration air for the deaeration unit 34 is determined only by quantity of the combustion air required by the combustion/electric power generation unit 40. It is therefore preferable to determine capacity of the unit 40 in response to quantity of the air to be used.

The combustion/electric power generation unit 40 can sufficiently exhibit the required function by a small-size unit. The electric power produced by this unit is used as a power for driving each unit in the contamination purification system. The electric power, when produced in excess of the requirement of the system, may be sold.

As described above, the contamination purification system of the present invention comprises 2 or more wells combined with a contamination purification section, and eventually decomposes a volatile organic compound by the combustion/electric power generation unit in the contamination purification section, thereby reducing size of the whole system and attaining self-sufficiency of electric power for operating the system.

### EXAMPLES

The system of the present invention is described by EXAMPLE by referring to FIGS. 1 and 6 which by no means limits the present invention.

Referring to FIG. 1, the contamination purification system was installed at the selected test site with the water-unsaturated stratum 1 and water-impermeable stratum 3 underground, where gasoline leaking out of an underground tank penetrated into soil and stayed in the soil 4 in the water-unsaturated stratum 1.

The system was composed of extraction wells 6 for extracting volatile organic compounds vaporizing from the soil and a contamination purification section 12 equipped with the suction fan 20 for collecting the volatile organic compounds together with air. The fan 21 was not provided in this EXAMPLE.

FIG. 6 outlines the structure of the combustion/electric power generation unit 40 in the contamination purification section It was equipped with a small-size turbine generator (Capstone's, brand name, Capstone Turbine Generator Model 330, producing electric power of 28 Kw·H) burning kerosene as the fuel. It could be supplied with air 11 containing the volatile organic compounds at the inlet of the combustor 41 from a separate route, and was so structured as to use the electric power it generated for driving the system components, e.g., the fans 20 and 21 and pump 23. The exhaust gas of high temperature and pressure and high kinetic energy, produced by the combustor 41, was directly blown to the gas turbine blade 42 to drive the motor of the electric power generator 43.

First, the suction fan 20 was started to collect the volatile organic compounds rising through the extraction well 6 together with air via the vapor-liquid separator 30, where the concomitant mist was removed from the air stream. The mist-free air 10 was supplied to the combustor 41 in the combustion/electric power generation unit 40.

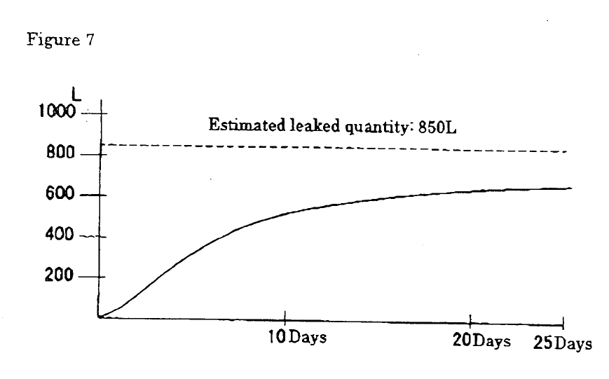

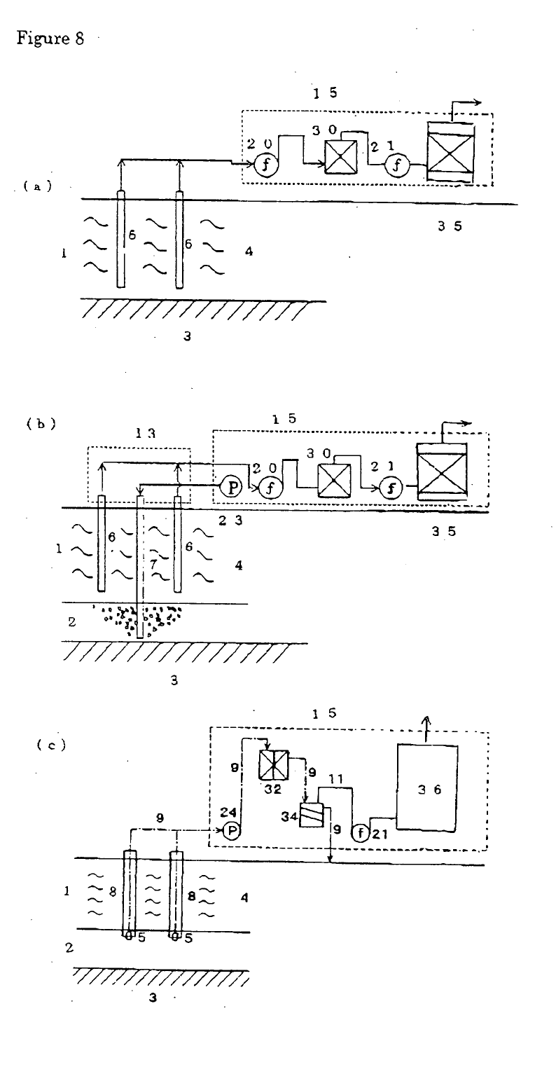

In this example, about 850L of gasoline was estimated to leak out, and air was collected by suction at 3 m³/minute to be used as the primary combustion air for the combustor 41. Content of the gasoline in the collected air was followed, and its quantity collected was estimated. The results are given in FIG. 7. The test was carried out for 25 days.

In FIG. 7, the solid line represents cumulative quantity of the gasoline recovered. This line shows a tendency of continuous increase, which demonstrates effectiveness of the present invention. The off-gas discharged from the turbine generator was monitored during the test period. Any volatile organic compound left unburnt was not detected.

This system produced electric power in excess of the requirement by the system (6 Kw·H), and the surplus power was consumed by a dummy heater.

As described above, the contamination purification system of the present invention comprises 2 or more wells combined with a contamination purification section, and eventually decomposes a volatile organic compound by the combustion/electric power generation unit in the contamination purification section. It is very high in industrial value, because it reduces size of the whole system and attains self-sufficiency of electric power for operating the system.

1. A contamination purification system for purification of an area contaminated with a volatile organic compound,
which is composed of an extraction well located in the contaminated area, gas suction/exhausting unit for extracting the volatile organic compound from the extraction well, vapor-liquid separator for separating water accompanying the extracted volatile organic compound, and combustion/electric power generation unit for transforming energy produced by combusting the separated/recovered volatile organic compound into electric power, wherein the electric power produced by the combustion/electric power generation unit is used as a power for driving the contamination purification system.

2. A contamination purification system for purification of an area contaminated with a volatile organic compound,
which is composed of an air-injection well and extraction well located in at least one of the water-impermeable, water-saturated and water-unsaturated stratum all located in the contaminated area, (at the upper end when located in the water-impermeable stratum), an air injection and gas suction/exhausting unit for extracting the volatile organic compound from the extraction well, vapor-Yukuaki liquid separator for separating water accompanying the extracted volatile organic compound, and combustion/electric power generation unit for transforming energy produced by combusting the separated/recovered volatile organic compound into electric power, wherein the electric power produced by the combustion/electric power generation unit is used as a power for driving the contamination purification system.

3. A contamination purification system for purification of an area contaminated with a volatile organic compound,
which is composed of a water pumping-up well located in the contaminated area, suction pump for lifting water containing a volatile organic compound through the pumping-up well, decomposing unit for purifying the lifted water, deaeration unit for aerating the water purified by the decomposing unit to recover the volatile organic compound, and combustion/electric power generation unit for transforming energy produced by combusting the recovered volatile organic compound into electric power, wherein the electric power produced by the combustion/electric power generation unit is used as a power for driving the contamination purification system.

4. A contamination purification system for purification of an area contaminated with a volatile organic compound,
which is composed of an extraction well and water pumping-up well all located in the contaminated area, gas suction/exhausting unit for extracting the volatile organic compound from the extraction well, vapor-liquid separator for separating water accompanying the extracted volatile organic compound, suction pump for lifting water containing a volatile organic compound through the pumping-up well, decomposing unit for purifying the lifted water, deaeration unit for aerating the water purified by the decomposing unit to recover the volatile organic compound, and combustion/electric power generation unit for transforming energy produced by combusting the separated/recovered volatile organic compound into electric power, wherein the electric power produced by the combustion/electric power generation unit is used as a power for driving the contamination purification system.

5. A contamination purification system for purification of an area contaminated with a volatile organic compound,
which is composed of an air-injection well, extraction well and water pumping-up well all located in at least one of the water-impermeable, water-saturated and water-unsaturated stratum in the contamination area (at the upper end when located in the water-impermeable stratum), an air injection and gas suction/exhausting unit for extracting the volatile organic compound from the extraction well, vapor-liquid separator for separating water accompanying the extracted volatile organic compound, suction pump for lifting water containing a volatile organic compound through the pumping-up well, decomposing unit for purifying the lifted water, deaeration unit for aerating the water purified by the decomposing unit to recover the volatile organic compound, and combustion/electric power generation unit for transforming energy produced by combusting the volatile organic compound, recovered by the vapor-liquid separator and deaeration unit, into electric power, wherein the electric power produced by the combustion/electric power generation unit is used as a power for driving the contamination purification system.

6. The contamination purification system of claim 1, wherein said combustion/electric power generation unit uses a gas turbine.

7. The contamination purification system of claim 3, wherein said decomposing unit decomposes the lifted water in the presence of ultraviolet ray or photocatalyst.

8. The contamination purification system of claim 2, wherein said combustion/electric power generation unit uses a gas turbine.

9. The contamination purification system of claim 3, wherein said combustion/electric power generation unit uses a gas turbine.

10. The contamination purification system of claim 4, wherein said combustion/electric power generation unit uses a gas turbine.

11. The contamination purification system of claim 5, wherein said combustion/electric power generation unit uses a gas turbine.

12. The contamination purification system of claim 4, wherein said decomposing unit decomposes the lifted water in the presence of ultraviolet ray or photocatalyst.

13. The contamination purification system of claim 5, wherein said decomposing unit decomposes the lifted water in the presence of ultraviolet ray or photocatalyst.
